(19) United States
(12) Patent Application Publication
(10) Pub. No.: US 2019/0012005 A1
(43) Pub. Date: Jan. 10, 2019

(54) METHOD AND DEVICE FOR ASYNCHRONOUS TOUCH AND ASYNCHRONOUS DISPLAY ON DUAL-SCREEN AND COMPUTER READABLE STORAGE MEDIUM

(71) Applicant: PAX COMPUTER TECHNOLOGY (SHENZHEN) CO.,LTD.

(72) Inventor: Xiaoqiang Xie, Shenzhen, Guangdong (CN)

(21) Appl. No.: 15/743,820

(22) PCT Filed: Aug. 2, 2017
(86) PCT No.: PCT/CN2017/095692

§ 371 Date: Jan. 11, 2018

(30) Foreign Application Priority Data
Jun. 30, 2017 (CN) 201710526719.2

(51) Int. Cl. G06F 3/041; G06F 3/14

(52) U.S. Cl. CPC G06F 3/041; G06F 2203/04104; G06F 3/1438

(57) ABSTRACT

A method and a device for asynchronous touch and asynchronous display on a dual-screen and a computer readable storage medium are provided. The method includes: detecting a touch event and determining a touch screen where the touch event occurs; acquiring an identification of a first touch screen when the touch event is an event occurring on the first touch screen; acquiring an identification of a second touch screen when the touch event is an event occurring on the second touch screen; and transmitting a corresponding content to a controller of the first touch screen or a controller of the second touch screen according to the identification of the first touch screen or the identification of the second touch screen to display the corresponding content on the first touch screen or the second touch screen.

### TECHNICAL FIELD

The present application pertains to the technical field of computer application, more particularly to a method and a device for asynchronous touch and asynchronous display on a dual-screen and a computer readable storage medium.

### BACKGROUND

Existing electronic devices typically have at least one display screen for displaying an application interface. With the development of the touch technology, these display screens are not only used to display the application interface, but also used as a man-machine interactive interface to achieve information interaction between man and machine.

As business interactions have become more and more dependent on electronic devices with display screens, single-screen electronic devices are less able to meet people's needs. For example, for financial institutions, such as banks, it is required that when dealing with a certain business, one interface is displayed for a bank staff on a terminal dealing with the certain business, and another interface is displayed for a guest. In presence of a plurality of people, a projector device can be equipped to easily display information for the people. However, when the information is required to be displayed in the case of one-to-one or one-to-few people, the utilization of the projector device is impractical, and is further a waste of resource.

Therefore, it is desired to achieve the asynchronous touch and asynchronous display on a dual-screen with relatively low cost.

### SUMMARY

The present application provides a method and a device for asynchronous touch and asynchronous display on a dual-screen and a computer readable storage medium, which achieve man-machine interaction by means of asynchronous touch and asynchronous display on the dual-screen.

A first aspect of the present application provides a method for asynchronous touch and asynchronous display on a dual-screen, applicable to an electronic device which can be connected with two touch screens. The method comprises:

detecting a touch event and determining a touch screen where the touch event occurs;

acquiring an identification of a first touch screen when the touch event is an event occurring on the first touch screen;

acquiring an identification of a second touch screen when the touch event is an event occurring on the second touch screen; and

transmitting a corresponding content to a controller of the first touch screen or a controller of the second touch screen according to the identification of the first touch screen or the identification of the second touch screen to display the corresponding content on the first touch screen or the second touch screen.

A second aspect of the present application provides a device for asynchronous touch and asynchronous display on a dual-screen, applicable to an electronic device which can be connected with two touch screens. The device comprises:

an event detection module configured to detect a touch event and determine a touch screen where the touch event occurs;

a first identification acquisition module configured to acquire an identification of a first touch screen when the touch event is an event occurring on the first touch screen;

a second identification acquisition module configured to acquire an identification of a second touch screen when the touch event is an event occurring on the second touch screen; and

a transmission module configured to transmit a corresponding content to a controller of the first touch screen or a controller of the second touch screen according to the identification of the first touch screen or the identification of the second touch screen to display the corresponding content on the first touch screen or the second touch screen.

A third aspect of the present application provides a terminal device, which comprises a memory, a processor, and a computer program stored in the memory and capable of operating in the processor, when the computer program is executed by the processor, the following steps are implemented:

detecting a touch event and determining a touch screen where the touch event occurs;

acquiring an identification of a first touch screen when the touch event is an event occurring on the first touch screen;

acquiring an identification of a second touch screen when the touch event is an event occurring on the second touch screen; and

transmitting a corresponding content to a controller of the first touch screen or a controller of the second touch screen according to the identification of the first touch screen or the identification of the second touch screen to display the corresponding content on the first touch screen or the second touch screen.

A fourth aspect of the present application provides a computer readable storage medium, the computer readable storage medium is configured to store a computer program, and upon the computer program being executed by a processor, the following steps are implemented:

detecting a touch event and determining a touch screen where the touch event occurs;

acquiring an identification of a first touch screen when the touch event is an event occurring on the first touch screen;

acquiring an identification of a second touch screen when the touch event is an event occurring on the second touch screen; and

transmitting a corresponding content to a controller of the first touch screen or a controller of the second touch screen according to the identification of the first touch screen or the identification of the second touch screen to display the corresponding content on the first touch screen or the second touch screen.

It is known from the above technical solutions provided by the present application that when the touch event is detected to be the event occurring on the first touch screen, the identification of the first touch screen is acquired, and when the touch event is detected to be the event occurring on the second touch screen, the identification of the second touch screen is acquired, and finally, according to the identification of the first touch screen or the identification of the second touch screen, a corresponding content is transmitted to a controller of the first touch screen or a controller of the second touch screen for displaying the corresponding content on the first touch screen or the second touch screen. Compared with the prior art, in the one aspect, the present application achieves the function of asynchronous touch and asynchronous display on the dual-screen and meets the interaction requirement under special application occasions; and in the other aspect, realizes the asynchronous touch and asynchronous display on the dual-screen in one electronic device without requiring adding any other device, such that the cost for achieving the asynchronous touch and asynchronous display on the dual-screen is reduced.

### BRIEF DESCRIPTION OF THE DRAWINGS

In order to more clearly illustrate the technical solutions in embodiments of the present application, the following drawings, which are to be used in the description of the embodiments or the prior art, will be briefly described. It will be apparent that the drawings described in the following description are merely embodiments of the present application. Other drawings may be obtained by those skilled in the art without paying creative labor.

FIG. 1 is a schematic diagram of an implementation flow of a method for asynchronous touch and asynchronous display on a dual-screen provided by one embodiment of the present application;

FIG. 2 is a structural schematic diagram of a device for asynchronous touch and asynchronous display on a dual-screen provided by one embodiment of the present application;

FIG. 3 is a structural schematic diagram of a device for asynchronous touch and asynchronous display on a dual-screen provided by another embodiment of the present application; and

FIG. 4 is a structural schematic diagram of a device for asynchronous touch and asynchronous display on a dual-screen provided by still another embodiment of the present application; and

FIG. 5 is a structural schematic diagram of a terminal device provided by one embodiment of the present application.

### DETAILED DESCRIPTION OF THE EMBODIMENTS

In the following description, for purposes of explanation but not limitation, specific details, such as particular system architecture, techniques, etc, are set forth in order to provide a thorough understanding of embodiments of the present application. However, it will be apparent to those skilled in the art that the present application may be practiced in other embodiments with less specific details. In other conditions, detailed descriptions of well-known systems, devices, circuits, and methods are omitted so as not to obscure the description of the present application with unnecessary details.

For the purpose of illustrating the technical solutions of the present application, specific embodiments are described as follows.

FIG. 1 is a schematic diagram of an implementation flow of a method for asynchronous touch and asynchronous display on a dual-screen provided by one embodiment of the present application, which primarily comprises steps S101-S104. The method exemplified in FIG. 1 is applicable to an electronic device that can connect with two touch screens, and is described in detail as follows:

S101, detecting a touch event and determining a touch screen where the touch event occurs.

In embodiments of the present application, the electronic devices, such as vehicle electronic devices, POS machines, cash registers, and karaoke devices, to which the method for asynchronous touch and asynchronous display on the dual-screen is applied, can connect with two touch screens. Users can touch any one of the two touch screens or simultaneously touch both touch screens for interaction, every time the users touch the touch screen, it is one touch event for the system. The system will detect the touch event and detect the touch screen where the touch event occurs, that is, detect which screen is touched by the user.

As one embodiment of the present application, the step of detecting the touch event and determining the touch screen where the touch event occurs can be as follows: determining whether the touch event occurs on the first touch screen or the second touch screen according to a screen coordinate corresponding to a touch when the touch event occurs on the dual-screen. In one embodiment of the present application, although the first touch screen and the second touch screen may be physically apart from each other, screen coordinates of the first touch screen and the second touch screen are centralized managed, thus, the system is able to determine whether the touch event occurs on the first touch screen or the second touch screen according to the touch corresponding to the screen coordinate when the touch even occurs on the dual-screen.

It should be noted that, in one embodiment of the present application, the first touch screen can be a main screen of an electronic device, and the second touch screen can be a secondary screen or a customer screen of the electronic device; the secondary screen or the customer screen is a touch screen that can be expanded for the electronic device. Thus, the second touch screen can be expandable screen of the electronic device, that is, the second touch screen can be a touch screen that is plugable into the electronic device.

S102, acquiring an identification of a first touch screen when the touch event is an event occurring on the first touch screen.

S103, acquiring an identification of a second touch screen when the touch event is an event occurring on the second touch screen.

In one embodiment of the present application, each touch screen has an identification corresponding thereto, that is, the touch screen and the identification of the touch screen can be bound in advance. When the touch event is the event occurring on the first touch screen, the identification of the first touch screen is acquired; and when the touch event is the event occurring on the second touch screen, the identification of the second touch screen is acquired. For example, when the identification of the touch screen is represented by display ID, the identification of the first touch screen can be 0, that is, display ID=0, and the identification of the second touch screen can be any non-zero, that is, the display ID thereof can be any value except 0. If the second touch screen is a kind of extended screen, then the display ID thereof can be variable during plug and pull thereof.

When the touch screen where the touch event occurs is determined, the touch event is transmitted to TouchedWindow of the corresponding touch screen. For example, when the touch event occurs on the first touch screen, the touch event is transmitted to the TouchedWindown of the first touch screen; and when the touch event occurs on the second touch screen, the touch event is transmitted to the TouchedWindown of the second touch screen, thereby realizing asynchronous touch on the dual-screen.

S104, transmitting a corresponding content to a controller of the first touch screen or a controller of the second touch screen, according to the identification of the first touch screen or the identification of the second touch screen to display the corresponding content on the first touch screen or the second touch screen.

In one embodiment of the present application, the electronic device has two controllers in addition to a central processing unit (CPU). One controller is used to control one of the touch screens via an interface, and the content to be displayed is also transmitted via such interface to the touch screen for display finally. Before the detection of the touch event and the determination of the touch screen where the touch event occurs, a display list of the first touch screen and a display list of the second touch screen can be constructed, that is, an identification bit of a display layer is compared with a touch screen to determine whether they match with each other; if a identification bit of a display layer matches with the touch screen, then the display layer having the identification bit match with the touch screen is added to the display list of the touch screen that matching with the identification bit. Each touch screen can correspond to one or more display layers that match with the touch screen, each display layer has a corresponding identification bit, and each touch screen can display the display layers that match with the touch screen. For example, when constructing the display list of the first touch screen and the display list of the second touch screen, an identification bit of a display layer-0 is compared with the first touch screen to determine whether they match with each other, if the identification bit of the display layer-0 matches with the first touch screen, the display layer-0 is then added to the display list of the first touch screen that matches with the identification bit. For another example, an identification bit of a display layer-4 is compared with the second touch screen to determine whether they match with each other, if the identification bit of the display layer-4 matches with the second touch screen, the display layer-4 is then added to the display list of the second touch screen that matches with the identification bit, etc. It should be noted that, the display list of each touch screen can correspond to the identification of the touch screen, moreover, the display list of each touch screen can be stored in a buffer.

After the display lists of the touch screens are constructed, the step of transmitting the corresponding content to the controller of the first touch screen or the controller of the second touch screen, according to the identification of the first touch screen or the identification of the second touch screen to display the corresponding content on the first touch screen or the second touch screen comprises: acquiring the display list of the first touch screen according to the identification of the first touch screen, and arranging a buffer memory corresponding to the display list of the first touch screen to the controller of the first touch screen; or acquiring the display list of the second touch screen according to the identification of the second touch screen, and arranging a buffer memory corresponding to the display list of the second touch screen to the controller of the second touch screen. Thus, asynchronous display on the dual-screen is achieved.

As described in the above, the second touch screen can be the extended screen, that is, the touch screen plugable into the electronic device. When the electronic device only has the first touch screen currently existing, it can be determined whether the second touch screen exists by detection of the interface, that is, the method exemplified in FIG. 1 further comprises: detecting a state of a plugable interface of the second touch screen; and if it is detected that the second touch screen have been inserted into the plugable interface, calling a callback function to inform a software driver that the second touch screen currently exists. Specifically, for an Android system, a rk_hwc_hdmi_thread thread is opened in an open function of a hwcomposer, and the thread functions in detecting a state of the plugable interface, that is, a state of an HDMI, when the extended screen is inserted, a callback functionhotplug registered in software (SF) is called in the hwcomposer to inform the SF driver existence of the second touch screen, thus, the DMS server is able to acquire the two touch screens, and an application program can code for asynchronous display via corresponding API.

It is known from the method for asynchronous touch and asynchronous display on the dual-screen that when the touch event is detected to be the event occurring on the first touch screen, the identification of the first touch screen is acquired, and when the touch event is detected to be the event occurring on the second touch screen, the identification of the second touch screen is acquired, and finally, according to the identification of the first touch screen or the identification of the second touch screen, a corresponding content is transmitted to a controller of the first touch screen or a controller of the second touch screen for displaying the corresponding content on the first touch screen or the second touch screen. Compared with the prior art, in the one aspect, the present application achieves the function of asynchronous touch and asynchronous display on the dual-screen and meets the interaction requirement under special application occasions; and in the other aspect, realizes the asynchronous touch and asynchronous display on the dual-screen in one electronic device without requiring adding any other device, such that the cost for achieving the asynchronous touch and asynchronous display on the dual-screen is reduced.

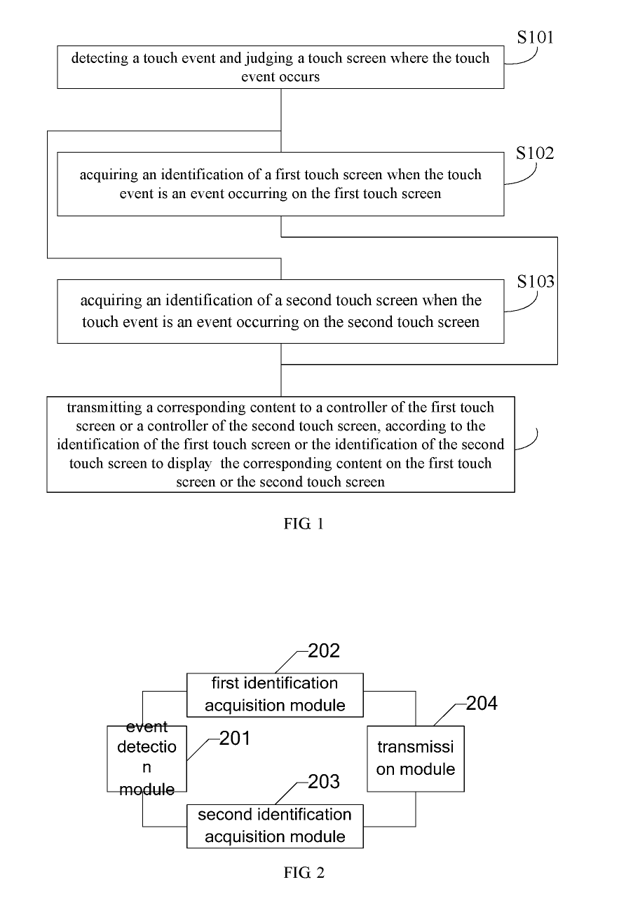

FIG. 2 is a schematic diagram of a device for asynchronous touch and asynchronous display on a dual-screen, which is applicable to the electronic devices, such as vehicle electronic devices, POS machines, cash registers, and karaoke devices, that can connect with two touch screens. The device for asynchronous touch and asynchronous display on the dual-screen exemplified in FIG. 2 mainly comprises: an event detection module 201, a first identification acquisition module 202, a second identification acquisition module 203, and a transmission module 204, which are described in detail as follows:

the event detection module 201 is configured to detect a touch event and determine a touch screen where the touch event occurs;

the first identification acquisition module 202 is configured to acquire an identification of a first touch screen when the event detection module 201 detects that the touch event is an event occurring on the first touch screen;

the second identification acquisition module 203 is configured to acquire an identification of a second touch screen when the event detection module 201 detects that the touch event is an event occurring on the second touch screen; and

the transmission module 204 is configured to transmit a corresponding content to a controller of the first touch screen or a controller of the second touch screen according to the identification of the first touch screen or the identification of the second touch screen to display the corresponding content on the first touch screen or the second touch screen.

It should be noted that the device provided by embodiments of the present application, since based on the same concept as embodiments of the method of the present application, has the same technical effect as embodiments of the method of the present application, specific contents thereof can refer to the description involving the embodiments of the method of the present application and would not be repeated again herein.

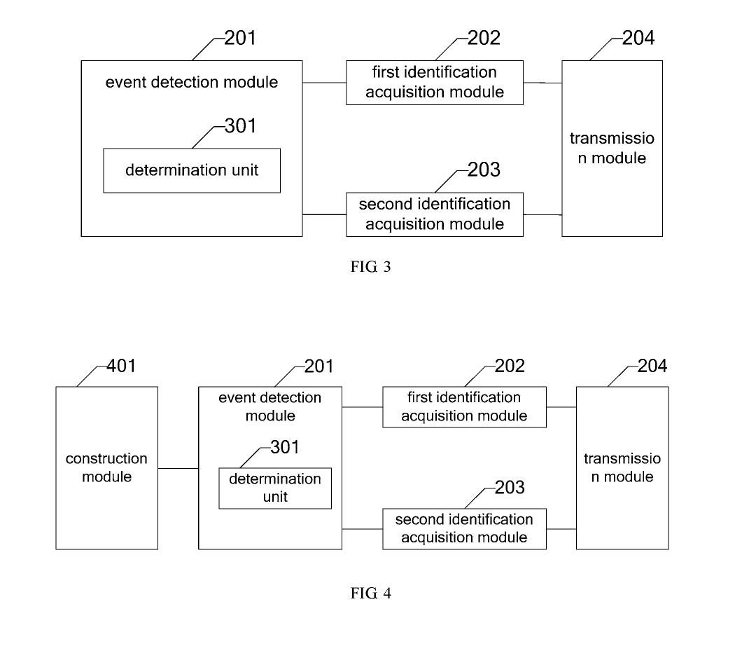

The event detection module exemplified in FIG. 2 can comprise a determination unit 301, such as the device for asynchronous touch and asynchronous display on the dual-screen exemplified in FIG. 3. The determination unit 301 is configured to determine whether the touch event occurs on the first touch screen or the second touch screen according to a screen coordinate corresponding to a touch when the touch event occurs on the dual-screen.

The device for asynchronous touch and asynchronous display on the dual-screen exemplified in FIG. 2 further comprises a construction module 401, such as the the device for asynchronous touch and asynchronous display on the dual-screen exemplified in FIG. 4. The construction module 401 is configured to construct a display list of the first touch screen and a display list of the second touch screen, before detecting the touch event and before determining the touch screen where the touch event occurs. Specifically, when the display list of the first touch screen and the display list of the second touch screen are constructed by the construction module 401, the identification bit of a display layer is compared with the touch screen to determine whether they match with each other, if the identification bit of the display layer matches with the touch screen, then the display layer having the identification bit match with the touch screen is added to the display list of the touch screen that matching with the identification bit.

The transmission module 204 exemplified in FIG. 4 can further comprises a first acquisition unit and a first setting unit; or, the transmission module 204 can further comprises a second acquisition unit and a second setting unit; of which:

the first acquisition unit is configured to acquire the display list of the first touch screen according to the identification of the first touch screen;

the first setting unit is configured to arrange a buffer setting corresponding to the display list of the first touch screen to the controller of the first touch screen;

the second acquisition unit is configured to acquire the display list of the second touch screen according to the identification of the second touch screen; and

the second acquisition unit is configured to arrange a buffer setting corresponding to the display list of the second touch screen to the controller of the second touch screen.

When the second touch screen is the touch screen plugable into the electronic device, if the electronic device has only the first touch screen currently existing, any of the devices of asynchronous touch and asynchronous display on the dual-screen exemplified in FIGS. 2-4 can further comprises a state detection module and a call module, of which:

the state detection module is configured to detect a state of a plugable interface of the second touch screen; and

the call module is configured to call a callback function to inform a software driver that the second touch screen currently exists if it is detected that the second touch screen have been inserted into the plugable interface.

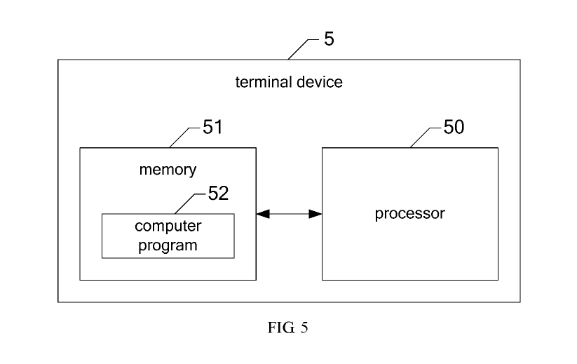

FIG. 5 is a structural schematic diagram of a terminal device provided by one embodiment of the present application. As shown in FIG. 5, the terminal device of this embodiment comprises: a processor 50, a memory 51, and a computer program 52 stored in the memory 51 and capable of operating in the processor 50, such as a program of a method of dual-screen separate contact and asynchronous display. When the computer program 52 is executed by the processor 50, steps of the above-described method of dual-screen separate contact and asynchronous display, such as steps S101-S104 as shown in FIG. 1, are implemented. Alternatively, when the computer program 52 is executed by the processor 50, functions of each module/unit of embodiments of the above-described device, such as, functions of the event detection module 201, the first identification acquisition module 202, the second identification acquisition module 203, and the transmission module 204 as shown in FIG. 2, are realized.

Exemplarily, the computer program 52 for the method for asynchronous touch and asynchronous display on the dual-screen primarily comprises: detecting the touch event and determining the touch screen where the touch event occurs; acquiring the identification of the first touch screen when the touch event is the event occurring on the first touch screen; acquiring the identification of the second touch screen when the touch event is the event occurring on the second touch screen; and transmitting the corresponding content to the controller of the first touch screen or the controller of the second touch screen according to the identification of the first touch screen or the identification of the second touch screen to display the corresponding content on the first touch screen or the second touch screen. The computer program 52 can be divided into one or more modules/units, the one or more modules/units are stored in the memory 51 and executed by the processor 50 to accomplish the present application. The one or more modules/units can be a series of instruction segments of the computer program capable of performing a particular function, and the instruction segments are used to describe execution process of the computer program 52 in a computing device 5. For example, the computer program 52 can be divided into the functions of the event detection module 201, the first identification acquisition module 202, the second identification acquisition module 203, and the transmission module 204 (modules in virtual appliance), and specific functions of each module are as follows: the event detection module 201 is configured to detect the touch event and determine the touch screen where the touch event occurs; the first identification acquisition module 202 is configured to acquire the identification of the first touch screen when the event detection module 201 detects that the touch event is the event occurring on the first touch screen; the second identification acquisition module 203 is configured to acquire an identification of a second touch screen when the event detection module 201 detects that the touch event is an event occurring on the second touch screen; and the transmission module 204 is configured to transmit the corresponding content to the controller of the first touch screen or the controller of the second touch screen according to the identification of the first touch screen or the identification of the second touch screen to display the corresponding content on the first touch screen or the second touch screen.

The terminal device 5 can comprise, but is not limited to, the processor 50 and the memory 51. It can be understood by those skilled in the art that FIG. 5 is only an example of the terminal device 5 but does not constitute limitation on the terminal device 5, and the terminal device 5 may include more or fewer components than those shown in the figure, or a combination of some components, or different components. For example, the terminal device may further include an input/output device, a network access device, a bus, etc.

The processor 50 can be a central processing unit (CPU), or other general processor, digital signal processor (DSP), application specific integrated circuit (ASIC), field-programmable gate array (FPGA), or other programmable logic devices, discrete gate or transistor logic device, and discrete hardware components, etc. The general processor can be micro processor or the processor can be any conventional processor.

The memory 51 can be an internal storage unit of the terminal device 5, such as a hard disk or a memory of the terminal device 5. The memory 51 can also be an external storage device of a relay server 5, such as a plug-in hard disk, a Smart Media Card (SMC), a Secure Digital (SD) card, a flash card, etc. that are equipped on the terminal device 5. Further, the a memory 51 can also include both the internal storage unit and the external storage device of the terminal device 5. The memory 51 is used to store the computer program and other programs or data necessitated by the terminal device. The memory 51 can also used to temporarily store data that have been output or are to be output.

Those skilled in the art may clearly understand that, for convenience and simplicity of description, divisions of the above-described functional units and modules are merely exemplified for illustration. In practice, the above-described function allocation may be accomplished by different functional units and modules according to requirements, that is, the internal structure of the device is divided into different functional units or modules to accomplish all or part of the above-described functions. The functional units and modules in the embodiments can be integrated in one processing unit, or each unit exists individually, or two or more units are integrated in one unit, the above-described integrated unit can be realized by adopting the form of the hardware or by adopting the form of the software functional unit. In addition, the specific names of each functional unit or module are only for the convenience of distinguishing each other, but are not intended to limit the protection scope of the present application. Specific working processes of the units or modules in the above-described system can refer to the corresponding processes in the above-described embodiments of the method and would not repeated herein.

In the above embodiments, the description of each embodiment is focused on different parts, and the parts that are not specifically described or recorded in some embodiments can refer to related descriptions in other embodiments.

One of ordinary skill in the art may be aware that, the units and algorithm steps of each example described in embodiments disclosed herein may be implemented by electronic hardware or a combination of computer software and electronic hardware. Whether these functions are implemented by hardware or software depends on the specific application and design constraints of the technical solutions. A person skilled in the art may use different methods to implement the described functions for each particular application, but such implementation should not be considered to be out of the scope of the present application

In embodiments provided by the present application, it should be understood that the disclosed apparatus/terminal device and method may be implemented in other manners. For example, embodiments of the device/terminal device described above are merely exemplary. For example, the division of modules or units is merely logical function division and may adopt other division in actual implementation. For example, multiple units or components can be combined or integrated into another system, or some of the features can be ignored or not executed. In addition, mutual coupling, direct coupling, or communication connection as shown or discussed may be indirect coupling or communication connection via some interfaces, devices, or units, and may be electrical, mechanical, or other forms

The units described as separate components may be or not be physically separated. The components displayed as units may be or not be physical units, that is, may be located in one place or may also be distributed on multiple network units. Some or all of the units may be selected according to actual needs to achieve the objects of the technical solution of the embodiments.

In addition, each functional unit in each embodiment of the present application may be integrated into one processing unit, or each unit may exist alone physically, or two or more units may be integrated into one unit. The above-mentioned integrated unit can be implemented in the form of hardware or in the form of software functional unit.

Integrated modules/units, if implemented in the form of software functional units and sold or used as independent products, may be stored in a computer-readable storage medium. Based on this understanding, all or part of the processes for implementing the method of the above embodiments may also be implemented by instructing relevant hardware through a computer program. A computer program for a method of restoring data during a power-off state of a device may be stored in a computer readable storage medium, when the computer program is executed by the processor, the steps of the above-described method of embodiments may be implemented, that is, detecting the touch event and determining the touch screen where the touch event occurs; acquiring the identification of the first touch screen when the touch event is the event occurring on the first touch screen; acquiring the identification of the second touch screen when the touch event is the event occurring on the second touch screen; and transmitting the corresponding content to the controller of the first touch screen or the controller of the second touch screen, according to the identification of the first touch screen or the identification of the second touch screen to display the corresponding content on the first touch screen or the second touch screen. Among them, the computer program includes computer program codes which can be source codes, object codes, executable documents, or some intermediate forms. The computer-readable medium may include any entity or device capable of carrying computer program codes, recording media, USB flash disks, removable hard disks, magnetic disks, optical disks, computer memories, read-only memories (ROM), random access memories (RAM), electrical carrier signals, telecommunication signals, and software distribution media, etc. It should be noted that the contents contained in the computer readable medium may be appropriately increased or decreased according to the requirements of legislation and patent practice in jurisdictions. For example, in some jurisdictions, according to legislation and patent practice, the computer readable medium does not include electrical carrier signals and telecommunication signals. The above embodiments are merely intended for describing the technical solutions of the present application, but not for limiting the present application. Although the present application is described in detail with reference to the above embodiments, it should be understood by those skilled in the art that modifications may still be made to the technical solutions described in the above embodiments or parts of technical features may be equivalently replaced; these modifications or replacements do not make the essence of the corresponding technical solutions depart from the spirit and scope of the technical solutions of the embodiments of the present application, and should be included in the present application within the scope of protection.

1. A method for asynchronous touch and asynchronous display on a dual-screen, applicable to an electronic device which can be connected with two touch screens, comprising:
detecting a touch event and determining a touch screen where the touch event occurs;
acquiring an identification of a first touch screen when the touch event is an event occurring on the first touch screen;
acquiring an identification of a second touch screen when the touch event is an event occurring on the second touch screen; and
transmitting a corresponding content to a controller of the first touch screen or a controller of the second touch screen according to the identification of the first touch screen or the identification of the second touch screen to display the corresponding content on the first touch screen or the second touch screen.

2. The method of claim 1, wherein the step of detecting the touch event and determining the touch screen where the touch event occurs comprises: determining whether the touch event occurs on the first touch screen or the second touch screen according to a screen coordinate corresponding to a touch when the touch event occurs on the dual-screen.

3. The method of claim 1, further comprising: before the step of detecting the touch event and determining the touch screen where the touch event occurs, constructing a display list of the first touch screen and a display list of the second touch screen.

4. The method of claim 3, wherein the step of transmitting the corresponding content to the controller of the first touch screen or the controller of the second touch screen according to the identification of the first touch screen or the identification of the second touch screen to display the corresponding content on the first touch screen or the second touch screen comprises:
acquiring the display list of the first touch screen according to the identification of the first touch screen, and arranging a buffer setting corresponding to the display list of the first touch screen to the controller of the first touch screen; or
acquiring the display list of the second touch screen according to the identification of the second touch screen, and arranging a buffer setting corresponding to the display list of the second touch screen to the controller of the second touch screen.

5. The method of claim 1, wherein the second touch screen is a touch screen that is plugable into the electronic device, and when the electronic device only has the first touch screen currently existing, the method further comprises:
detecting a state of a plugable interface of the second touch screen; and
if it is detected that the second touch screen have been inserted into the plugable interface, calling a callback function to inform a software driver that the second touch screen currently exists.

6. A device for asynchronous touch and asynchronous display on a dual-screen, applicable to an electronic device which can be connected with two touch screens, comprising:
an event detection module configured to detect a touch event and determine a touch screen where the touch event occurs;
a first identification acquisition module configured to acquire an identification of a first touch screen when the touch event is an event occurring on the first touch screen;
a second identification acquisition module, configured to acquire an identification of a second touch screen when the touch event is an event occurring on the second touch screen; and
a transmission module configured to transmit a corresponding content to a controller of the first touch screen or a controller of the second touch screen according to the identification of the first touch screen or the identification of the second touch screen to display the corresponding content on the first touch screen or the second touch screen.

7. The device of claim 6, wherein the event detection module comprises a determination unit, configured to determine whether the touch event occurs on the first touch screen or the second touch screen according to a screen coordinate corresponding to a touch when the touch event occurs on the dual-screen.

8. The device of claim 1, further comprising a construction module configured to construct a display list of the first touch screen and a display list of the second touch screen before detecting the touch event and before determining the touch screen where the touch event occurs.

9. A terminal device, comprising: a memory, a processor, and a computer program which is stored in the memory and can be operated in the processor; wherein upon the computer program being executed by the processor, steps of the method of claim 1 are implemented.
